(19) United States
(12) Patent Application Publication
(10) Pub. No.: US 2008/0027966 A1
(43) Pub. Date: Jan. 31, 2008

(54) DYNAMIC CREATION OF STAR-SCHEMA DATABASE STRUCTURES AND CUBES

(76) Inventors: Benjamin M. Parees, Durham, NC (US); James Thorpe, Cary, NC (US); Prasad Vishnubhotla, Round Rock, TX (US)

Correspondence Address: MOORE & VAN ALLEN, PLLC For IBM, P.O. Box 13706, Research Triangle Park, NC, 27709, US

(21) Appl. No.: 11/459,714

(22) Filed: Jul. 25, 2006

(51) Int. Cl. G06F 7/00

(52) U.S. Cl. 707/102

(57) ABSTRACT

A method for creation of a database structure and associated cube may include identifying all processes associated with an observation model and identifying any metrics associated with each process to be recorded. The method may also include constructing a database schema to store the metric data and provide appropriate interrelations between the processes. The method may further include creating a cube model and a cube based on the database schema that can be queried to provide desired output information.

### BACKGROUND OF THE INVENTION

The present invention relates to storing and managing data related to processes, such as business processes and the like, and more particularly to dynamic creation of star-schema database structures and cubes.

Of importance in managing any process, such as a business process or the like, is the ability to efficiently store, sort, retrieve and present data related to the process. The data to be stored may be of an indeterminate structure and may be definable only by the process being monitored. Some processes may have a particular set of interesting attributes that should be stored or recorded, while others may have an entirely different set, unique to that particular process. For example, online ordering processes may need to record product prices and quantities while human resources processes may need to record marital status information, starting salaries and the like. For efficient operation, such data is desirably stored and retrievable in an extremely efficient and reliable manner for high throughput and high availability. Systems and methods for such operations are typically customized for the process and manually developed. They are typically not reusable on other processes because the data to be recorded may be completely different. Additionally, any changes to the process may require manual updating to support the new data to be stored.

### BRIEF SUMMARY OF THE INVENTION

In accordance with an embodiment of the present invention, a method for creation of a database structure and an associated cube may include identifying all processes associated with an observation model and identifying any metrics associated with each process to be recorded. The method may also include constructing a database schema to store the metric data and provide appropriate interrelations between the processes. The method may further include creating a cube model and a cube based on the database schema that can be queried to provide-desired output information.

In accordance with another embodiment of the present invention, a system for creation of a database structure and an associated cube may include a schema generator to construct a database schema to store metric data and provide appropriate interrelations between processes of an observation model. The schema generator may include a module to generate a table corresponding to each process in the observation model. The schema generator may also include another module to provide a column in each table to store each metric associated with a particular process corresponding to the table. The system may also include a module to create a cube based on the database schema that can be queried to provide desired output information.

In accordance with another embodiment of the present invention, a computer program product for creation of a database structure and an associated cube may include a computer usable medium having computer usable program code embodied therein. The computer usable medium may include computer usable program code configured to construct a database schema to store metric data and provide appropriate interrelations between a plurality of processes associated with a process model. The computer usable medium may also include computer usable program code configured to create a cube based on the database schema that can be queried to provide desired output information.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an exemplary method for dynamic creation of star-schema database structures or the like and cubes in accordance with an embodiment of the present invention.

FIG. 2 is a block diagram of an example of a cube model and how metadata objects fit together and map to a relational star-schema database structure or the like in accordance with another embodiment of the present invention.

FIG. 3 is another example of a cube model based on a star-schema database structure or the like in accordance with an embodiment of the present invention.

FIG. 4 is a diagram of an example of a product dimension based on the cube model of FIG. 3 in accordance with an embodiment of the present invention.

FIG. 5 is a diagram of an example of a cube based on the cube model of FIG. 3 in accordance with an embodiment of the present invention.

FIG. 6 is a flow chart of an example of a method to create cube model objects and related parameters associated with creation of a star-schema database structure and a cube in accordance with an embodiment of the present invention.

FIG. 7 is a flow chart of an example of a method to create an internal measure reference object or instances count associated with creation of a star-schema database structure and a cube in accordance with an embodiment of the present invention.

FIG. 8 is a flow chart of an example of a method to create internal objects to represent time dimension and related metrics associated with creation of a star-schema database structure and a cube in accordance with an embodiment of the present invention.

FIG. 9 is a flow chart of an example of a method for metric processing associated with creation of a star-schema database structure and a cube in accordance with an embodiment of the present invention.

FIGS. 10A and 10B (collectively FIG. 10) are a flow chart of an example of a method for metadata file processing associated with creation of a star-schema database structure and a cube in accordance with an embodiment of the present invention.

FIG. 11 is a flow chart of an example of a method for timer and counter processing associated with creation of a star-schema database structure and a cube in accordance with an embodiment of the present invention.

FIG. 12 is a diagram of an exemplary system for dynamic creation of a star-schema database structure and a cube in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

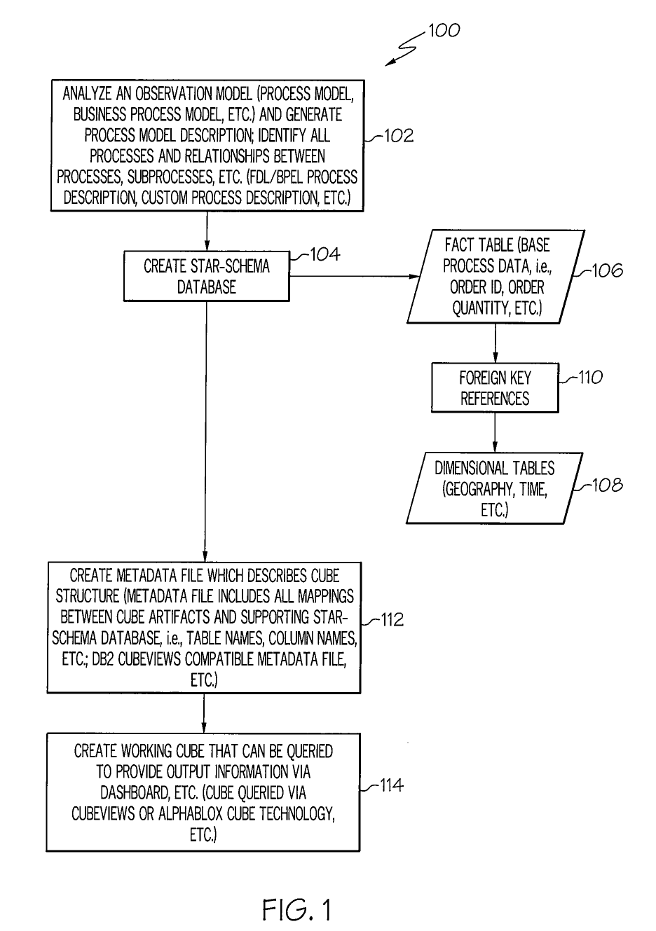

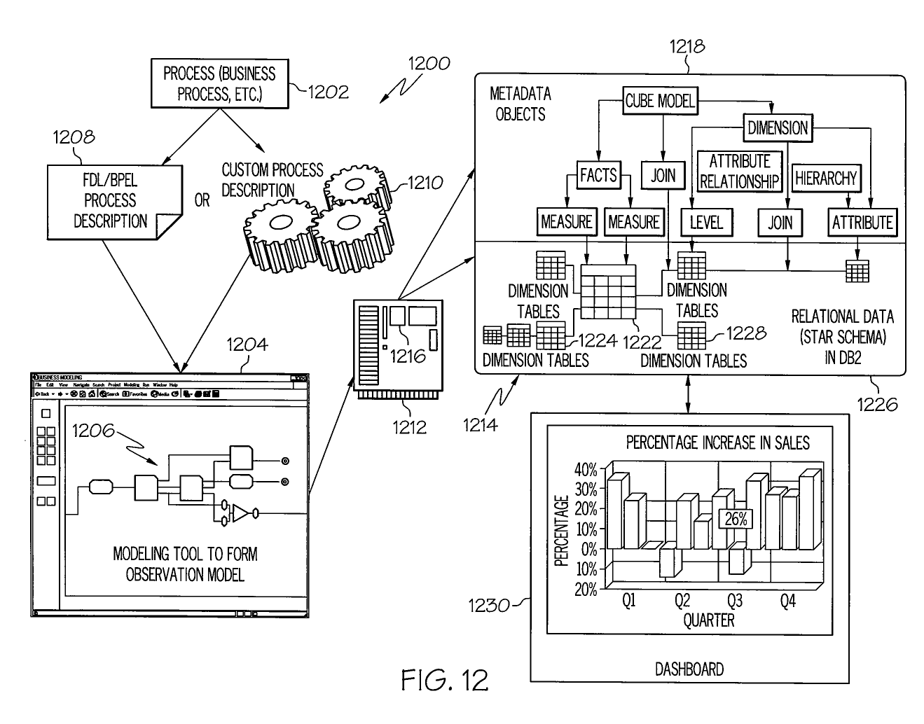

FIG. 1 is a flow chart of an exemplary method 100 for dynamic creation of star-schema database structures or the like and cubes in accordance with an embodiment of the present invention. In module or block 102, an observation model may be analyzed or formed by a modeling tool or the like as will be described in more detail with reference to system 1200 in FIG. 12. The observation model may be a process model, business process model or any type of process that may be modeled as described herein. A process model description may be generated. All processes associated with the model may be identified and all relationships between processes, subprocesses or the like may be identified and defined. The process model description may be developed by or involve a Flow Definition Language (FDL) or Business Process Execution Language (BPEL) process description, custom process description or other means of describing a process model digitally or electronically. The observation model may be metadata on top of the FDL/BPEL process description.

As an example of an observation model, a business process model may be a flow diagram indicating the steps that may be involved in a business process, such as the handling of an online store order. For example, first an order may be received followed by payment for the order being processed. Next the item ordered may be packaged for shipping, followed by shipping the package. Each step may be a subprocess within an overall online-ordering process. Each step or operation may have information associated with it, such as how long did it take to process payment, how much the item weighed when packaged, what is the tracking number provided when the item was shipped and similar information. The process model may have a specific structure that indicates the relationship between a process and its subprocesses or other processes. The model may be formed as an XMI file. XMI is an acronym for XML Metadata Interchange format which is an object-based model for exchanging program data across a network, such as the Internet, intranet or other type network. XML is extensible Markup Language used to define data elements on a Web page or in business-to-business documents.

In module or block 104, a star-schema database structure or similar database structure may be created. The star-schema structure may be automatically created from the observation model. An example of creating a star-schema database structure is described in U.S. patent application Ser. No. 11/422,105, filed Jun. 5, 2006, and entitled “Dynamic Optimized Datastore Generation and Modification for Process Models,” which is assigned to the same assignee as the present application and incorporated herein in its entirety by reference. Creating a star-schema database may involve forming a fact table 106 and one or more dimension tables 108. A fact table may include base process data. For example, in a business process the fact table may include order identification information, order quantity, order cost and similar fact data related to orders. A dimension table may include geographic data, time data and similar data of a dimensional nature. Foreign key references 110 may be defined to link data in the fact table 106 to data in respective dimension tables 108.

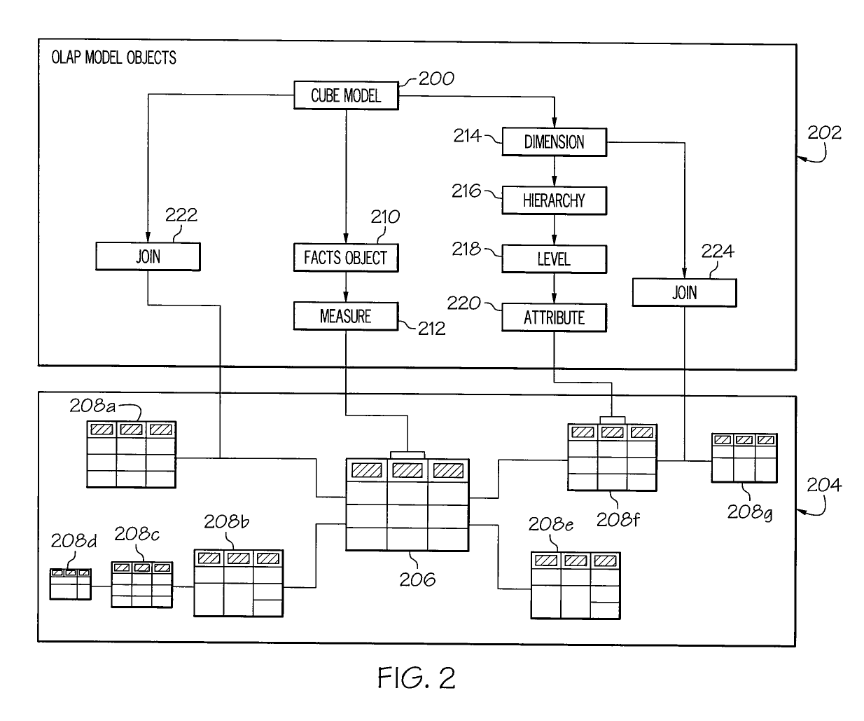

In module or block 112, a metadata file may be created which describes a cube structure. The metadata file may include mappings between cube artifacts and a supporting star-schema database as will be described in more detail with reference to FIG. 2. Examples of the metadata may include table names, column names and other references between cube artifacts and data in the supporting star-schema database.

In module or block 114, a working cube may be created that can be queried by a user to provide output information via a user interface, such as a dashboard or the like as described in more detail herein. A cube is an arrangement of data in arrays that allow faster access and analysis of data than a conventional two dimensional spreadsheet. A cube may be thought of as an extension to a two-dimensional array of a spreadsheet to a three-dimensional or higher order array. A cube may permit analysis of financial data or the like by product, time-period, city, type of revenue and cost, comparison of actual data to budget and the like. A cube may be queried via IBM DataBase 2 (DB2) database management system (DBMS) Cube Views, Alphablox cube technology or similar applications for analyzing data in a cube arrangement. DB2, Cube Views and Alphabox are trademarks of the IBM Corporation in the United States, foreign countries or both. The cube model and cube based on the database schema may be automatically created as described in more detail herein.

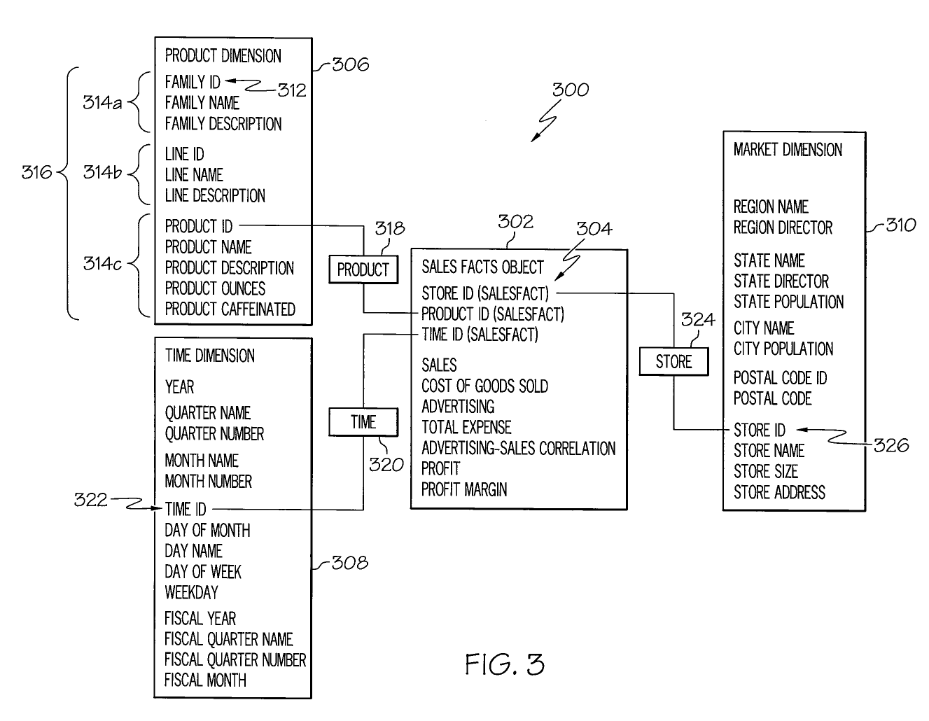

FIG. 2 is a block diagram of an example of a cube model 200 and how metadata objects 202 fit together and map to a relational star-schema database structure 204 or the like in accordance with another embodiment of the present invention. As previously discussed, the star-schema database structure 204 may include a fact table 206 and a plurality of dimension tables 208. The metadata objects 202 may be referred to as online analytical processing (OLAP) model objects. The metadata objects 202 may include a Facts object 210. Each facts object 210 may have one or more measures 212 or parameters that can be measured or a value recorded. Referring also to FIG. 3, FIG. 3 is an example of a cube model 300 based on a star-schema database structure for a business process, such as sale of goods, in accordance with an embodiment of the present invention. The cube model 300 includes a sales facts object 302. The sales facts object 302 may include a plurality of measures 304 or parameters that may each have a value that may be recorded. Examples of measures 304 within the sales facts object 302 include Store ID, Product ID, Time ID, Sales, Cost of goods sold, Advertising, Total expense, Advertising-sales correlation, Profit, Profit margin or other parameters or measures that may be recorded.

Referring back to FIG. 2, another metadata object 202 in the cube model 200 is a Dimension 214. The dimension 214 may be broken down into a hierarchy 216 and the hierarchy may be further divided by level 218. Each level 218 may be further subdivided into attributes 220. The example of the cube model 300 in FIG. 3 includes a Product dimension 306, a Time dimension 308 and a Market dimension 310. Each dimension 306-310 includes a plurality of attributes 312 with are grouped in levels 314 and the levels 314 may be in a hierarchy 316.

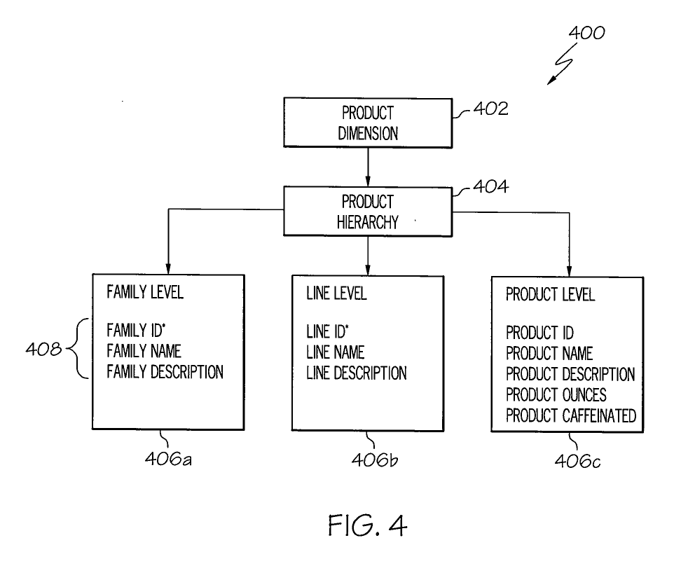

FIG. 4 is a diagram of an example of a dimension structure 400 based on the cube model 300 of FIG. 3 in accordance with an embodiment of the present invention. The dimension structure 400 illustrated in FIG. 4 is a Product dimension 402 and corresponds to the Product dimension 306 of FIG. 3. As previously discussed, the Product dimension 402 may be subdivided into a Product hierarchy 404 which includes a plurality of levels 406. In the example of FIG. 4 the product hierarchy includes a Family level 406a, a Line level 406b and a Product level 406c. Within each level 406 there may be a plurality of attributes 408. For example, attributes in the Family level 406a may include a Family ID, a Family name, a Family description or similar attributes. Similarly, the Line level 406b may include attributes like Line ID, Line name, Line description or the like. Examples of attributes in the Product level 406c may include Product ID, Product name, Product description, Product ounces, Product caffeinated or other attributes.

Referring back to FIG. 2, the cube model 200 may also include a join to make a relationship between the fact table and a dimension table, such as join 222 that maps a relationship between a dimension table 208a and the fact table 206. A join may also map a relationship between dimension tables, such as join 224 which maps a relationship between a dimension table 208g and another dimension table 208f. Referring also to FIG. 3, a Product join 318 may link the Sales facts object 302 to specific attributes 314 in the Product dimension 306. Similarly, a Time join 320 may link a Time ID measure 304 to Time ID attributes 322 in the Time dimension table 308. A Store join 324 may link a Store ID measure to Store ID attributes 326 in the Market dimension table 310.

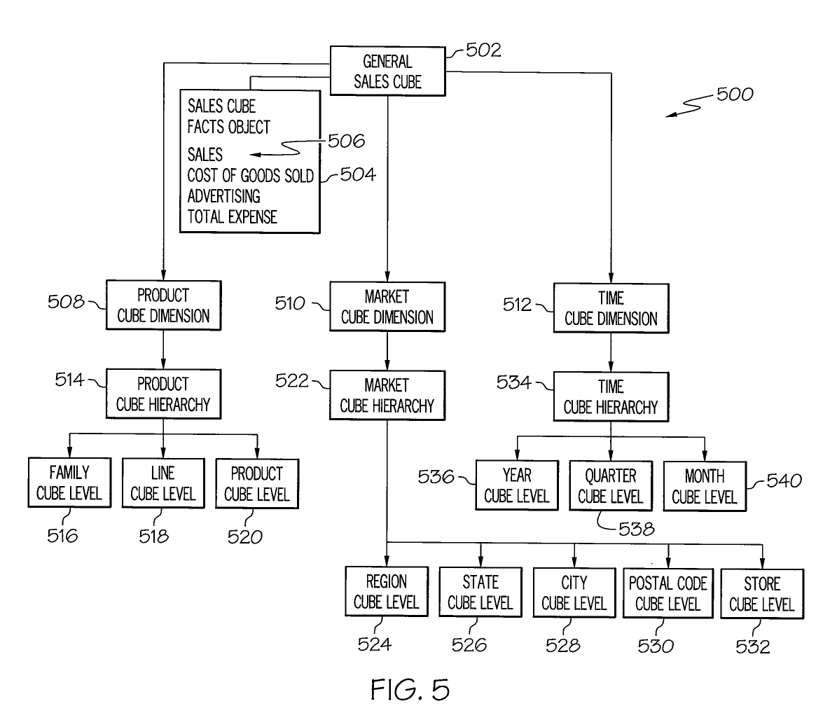

FIG. 5 is a diagram of an example of a cube 500 based on the cube model 300 of FIG. 3, in accordance with an embodiment of the present invention. The example of the cube 500 illustrated is a

General sales cube 502. The General sales cube 502 may link to a Sales cube facts object 504. The Sales cube facts object 504 may include measures 506, such as Sales, Cost of goods sold, Advertising, Total expenses or similar measures or parameters for which values may be determined and stored.

The General sales cube 502 may also be linked to a Product cube dimension object 508, a Market cube dimension object 510 and a Time cube dimension object 512. Similar to that previously described, each cube dimension 508, 510, and 512 may include a cube hierarchy including multiple levels. This represents a structure in terms of what DB2 Cube Views may provide. However, under some circumstances there may not be enough information in a business measures model (xmi file) to generate multiple levels. In accordance with at least one embodiment of the present invention, a granularity level may be used within the model to build the only level for a dimension. The granularity level may be a number from 0 to n. Many metrics may be included in the model that may all be associated with one dimension. For a given metric, the higher the number, the more granular the metric. Accordingly, a relatively simple Cube Views metadata model may be provided without necessarily exploiting any and all capabilities provided by DB2 Cube Views.

In the example of FIG. 5, the Product cube dimension 508 may include a Product cube hierarchy 514 which may include a Family cube level 516, a Line cube level 518 and a Product cube level 520. The Market cube dimension 510 may include a Market cube hierarchy 522 which may include a Region cube level 524, a State cube level 526, a City cube level 528, a Postal cube level 530, a Store cube level 532 or similar levels. The Time cube dimension 512 may include a Time cube hierarchy 534 that may include a Year cube level 536, a Quarter cube level 538, a Month cube level 540 or similar cube levels.

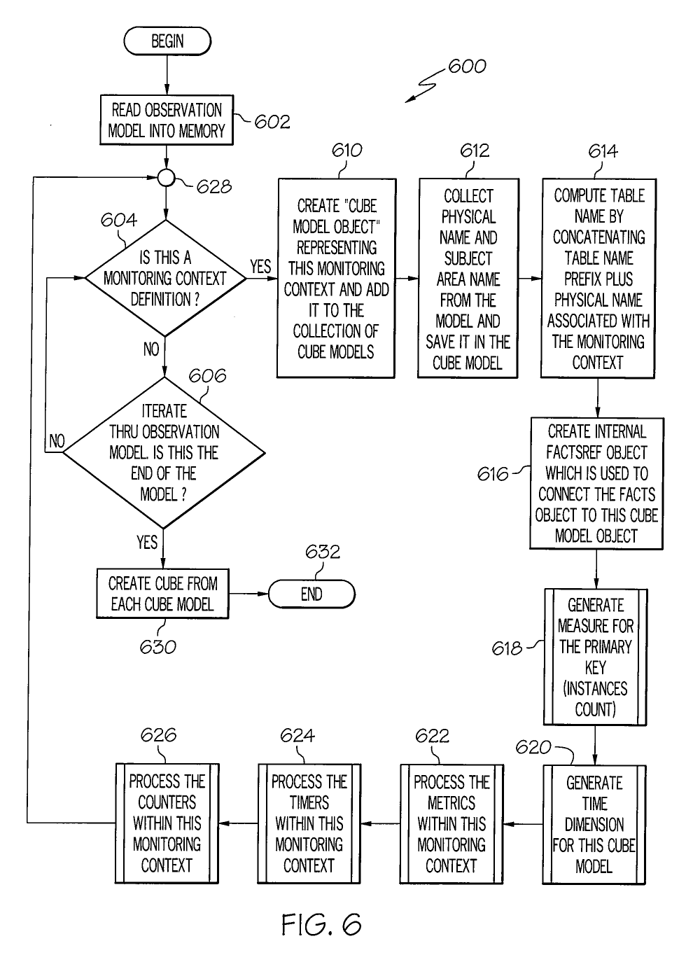

FIG. 6 is a flow chart of an example of a method 600 to create cube model objects and related parameters associated with creation of a star-schema database structure and at least one cube in accordance with an embodiment of the present invention. The method 600 may create cube model objects similar to those described with respect to FIGS. 2 and 3 and a cube or cubes similar to that described with respect to FIG. 5. Depending upon how complicated an observation model may be there could be a plurality of cube models and cubes. For each monitoring context, there may be one cube model and one cube. A monitoring context may be a process object of an observation model that is intended to be monitored during operation of the process.

In block 602, an observation model may be read into a memory of a processing system or schema generator as will be described in more detail with reference to FIG. 12. In block 604, a determination may be made whether a process object of the observation model is a monitoring context definition. If the process object is not a monitoring context definition, the method 600 may advance to block 606. In block 606, the method 600 may iterate through each process object of the observation model and a determination may be made in block 604 if the process object is a monitoring context definition.

If the process object is a monitoring context definition in block 604, the method 600 may advance to block 610. In block 610, a cube model object may be created. The cube model object may be similar to cube model objects 202 described with reference to FIG. 2. The cube model object represents the monitoring context and may be added to a collection of cube models.

In block 612, a physical name and subject area name from the cube model object may be collected and saved in the cube model. In block 614, a table name may be computed or determined by concatenating a table name prefix plus the physical name associated with the monitoring context. For example, a table name prefix may be ACT_for activity instances and FCT_(fact table) otherwise. The table names prefix used for dimension tables may be ADIM_for activity instances and DIM_otherwise.

In block 616, an internal FactRef object may be created which may be used to connect a Facts object, such as Facts object 210 (FIG. 2) to this particular cube model object.

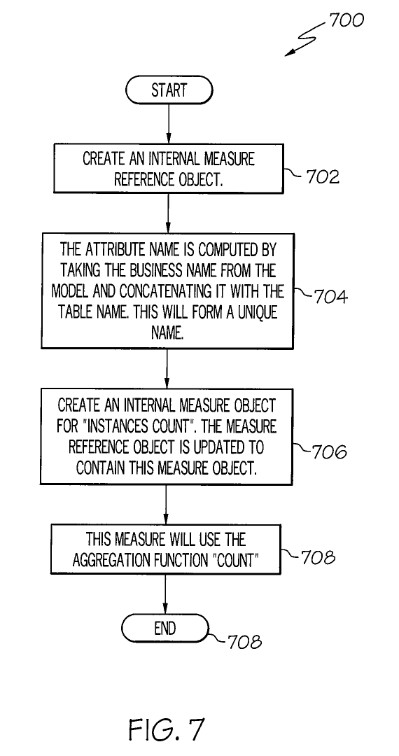

In block 618, a measure for a primary key, similar to measure 212 in FIG. 2, may be generated. The primary key may correspond to an instances count. An example of a method 700 for generating a primary key or instances count will be described with reference to FIG. 7. A primary key may define a set of columns in a database table that uniquely identify a row in the table. That is, no matter how many rows are in the table, no two rows can have the same value for all of the primary key columns simultaneously.

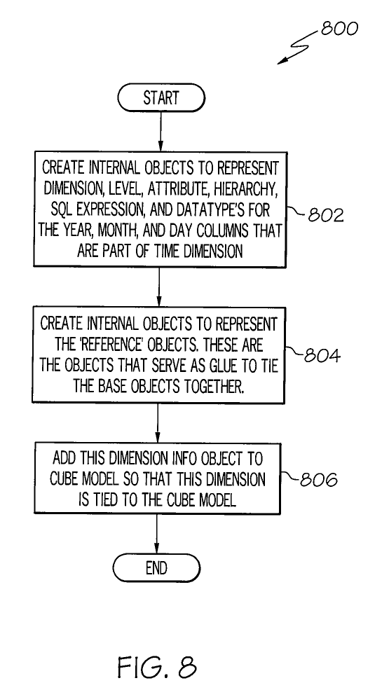

In block 620, a time dimension may be generated for the cube model. An example of a method 800 for generating a built-in time dimension will be described with reference to FIG. 8. Every monitoring context has a predetermined creation time and termination time. These predetermined fields make use of the time dimension definition.

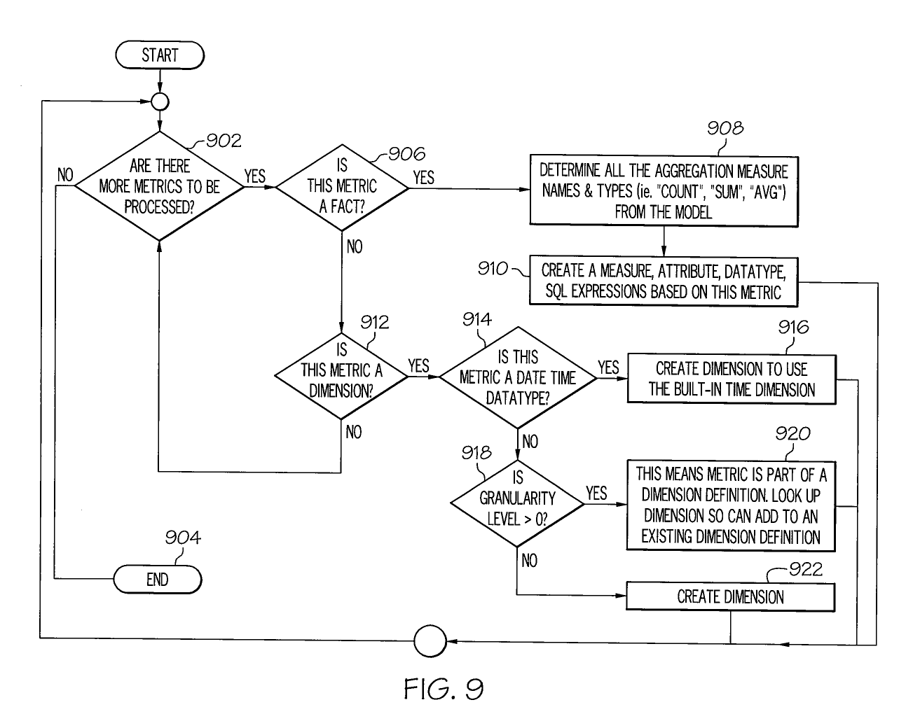

In block 622, metrics within the current monitoring context may be processed. An example of a method 900 for processing metrics within a monitoring context will be described in more detail with reference to FIG. 9.

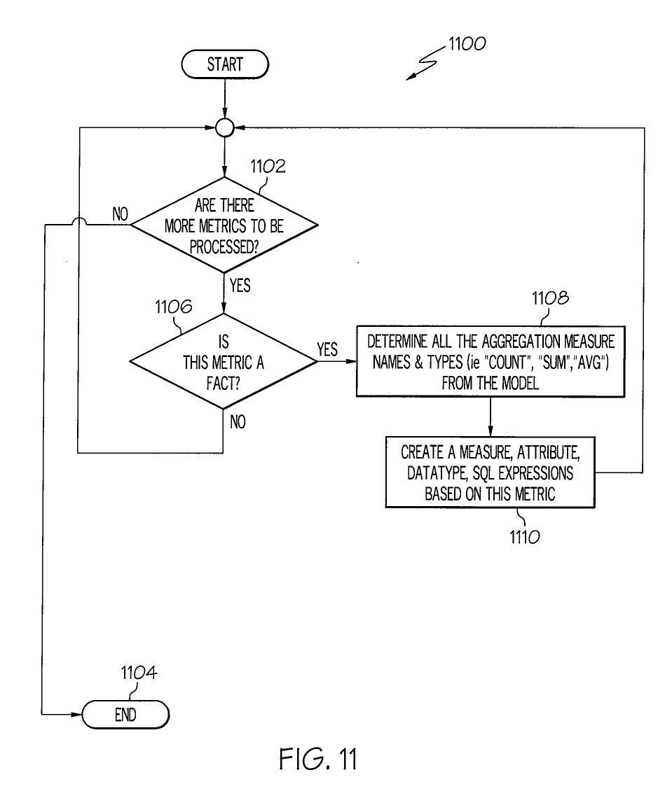

Timers within the current monitoring context being processed may be processed in block 624 and counters within the current monitoring context may be processed in block 626. An example of a method 1100 for processing timers and counters will be described with reference to FIG. 11. The method 600 may then return to junction 628 where the method 600 may consider whether the next process object in the observation model is a monitoring context definition in block 604. The method 600 may then proceed as previously described.

If the method 600 has iterated through the observation model in block 606 and is at the end of the model, the method 600 may advance to block 630. At this point, a plurality of cube models may have been created to support the observation model. In block 630, a cube may be created for each cube model derived from the observation model. The cube definition may include all of the measures and all of the dimensions that are contained within the cube model. The method 600 may then end at termination 632.

FIG. 7 is a flow chart of an example of a method 700 to create an internal measure reference object or instances count associated with creation of a star-schema database structure and a cube in accordance with an embodiment of the present invention. The method 700 may be used to generate a measure for the primary key or instances count in block 618 of the method 600 (FIG. 6). In block 702, an internal measure reference object may be created. The measure reference object may be similar to measure object 212 described with reference to the cube model 200 of FIG. 2.

In block 704, an attribute name may be computed by taking a business name from the model and concatenating it with the table name associated with the attribute. This will form a unique name. In block 706, an internal measure object for “InstanceCount” may be created. The measure reference object may be updated to contain this measure object. In block 708, the updated measure object may be used as the aggregation function “COUNT.”

FIG. 8 is a flow chart of an example of a method 800 to create internal objects to represent time dimension and related metrics associated with creation of a star-schema database structure and a cube in accordance with an embodiment of the present invention. The method 800 may be used to generate the time dimension for the cube model in block 620 of the method 600 (FIG. 6). As previously described, every monitoring context has a predetermined creation time and termination time. These predetermined fields may make use of the time dimension definition. In block 802, internal objects may be created to represent dimension, level, attribute, hierarchy, Structured Query Language (SQL) expression, data type for the year, month and day columns that are part of a time dimension or similar internal objects. The structure of the internal objects may be similar to the cube model objects 202 illustrated in FIG. 2. The time dimension may be similar to the time dimension 308 of FIG. 3. In another embodiment of the present invention, the time dimension may only include the year, month and day.

In block 804, internal objects may be created to represent reference objects. These objects may serve to tie or link the base objects together. In block 806, the dimensionInfo object formed by blocks 802 and 804 may be added to the cube model so that the dimension is tied to the cube model.

FIG. 9 is a flow chart of an example of a method 900 for metric processing associated with creation of a star-schema database structure and a cube in accordance with an embodiment of the present invention. The method 900 may be used for processing all metrics within a monitoring context in block 622 of the method 600 (FIG. 6). In block 902 a determination may be made if there are more metrics within a monitoring context to be processed. If not, the method 900 may end at termination 904. If there are more metrics to be processed in block 902, the method 900 may advance to block 906. In block 906, a determination may be made if the metric is a fact metric. If the metric is a fact metric, the method 900 may advance to block 908.

In block 908, all the aggregation measure names and types may be determined from the model. Examples of the aggregation measure names and types may include “count,” “sum,” “avg,” or similar aggregation measure names and types. In block 910, a measure, attribute, dataType, and SQL expressions based on the metric may be created. The method 900 may then return to block 902 where the determination is made if there are more metrics within the current monitoring context to be processed. The method 900 may then proceed as previously described.

If a determination is made in block 902 that the metric is not a fact metric, the method 900 may advance to block 912. In block 912, a determination may be made whether the metric is a dimension. If the metric is not a dimension, the method 900 may return to block 902. If the metric is a dimension in block 912, the method 900 advances to block 914. In block 914, a determination may be made if the metric is a date time data type. If the metric is a date time data type, a dimension to use the built-in time dimension, such as from the method 800 in FIG. 8, may be created in block 916. The method 900 may then return to block 902 to process the next metric.

If the metric is not a date time data type in block 914, the method 900 may proceed to block 918. In block 918, a determination may be made whether the granularity of the metric is greater than 0. Granularity may refer to the number of metrics related to a particular dimension. As an example, an observation model may be created and the model may include a set of metrics that conceptually relate geography. A number “n” of individual metrics may be created and tied to a dimension that may be named geography. These metrics may be ordered to have meaning and the way to order the metrics is the granularity level. Accordingly, granularity may be a number and the higher the number, the more granular the meaning is. To further the example, if “Planet” is a metric in the dimension geography with a granularity level of 0, this is the most course grain metric. Additional metrics like Country, State, City, and Street, could be added and a respective higher granularity level may be assigned to each one. For instance, granularity level 1 could be assigned for Country, 2 for State, 3 for City, and 4 for Street. This is conceptually how a level can be created. This may not become evident until one starts drilling down in a dashboard view of the model or cube.

Another example of a metric that is defined to be a dimension may be OrderStatus. In this example, only one metric may be defined and by default, its granularity level is 0. This dimension would contain all possible statuses like OrderCreated, OrderBackOrdered, or OrderShipped. This is a fairly plain dimension and one would not be able to drill down at all but it is still powerful in the sense that one can see reports, such as ‘show me all the back orders from January 1 to June 30’ as an example.

If the granularity is greater than 0, this means the metric is part of a dimension definition. The metric may then be added to an existing dimension definition in block 920. The method 900 may then return to block 902 to consider the next metric.

If the granularity level is not greater than 0 in block 918, a dimension may be created in block 922. The method 900 may then return to block 902 and proceed as previously described.

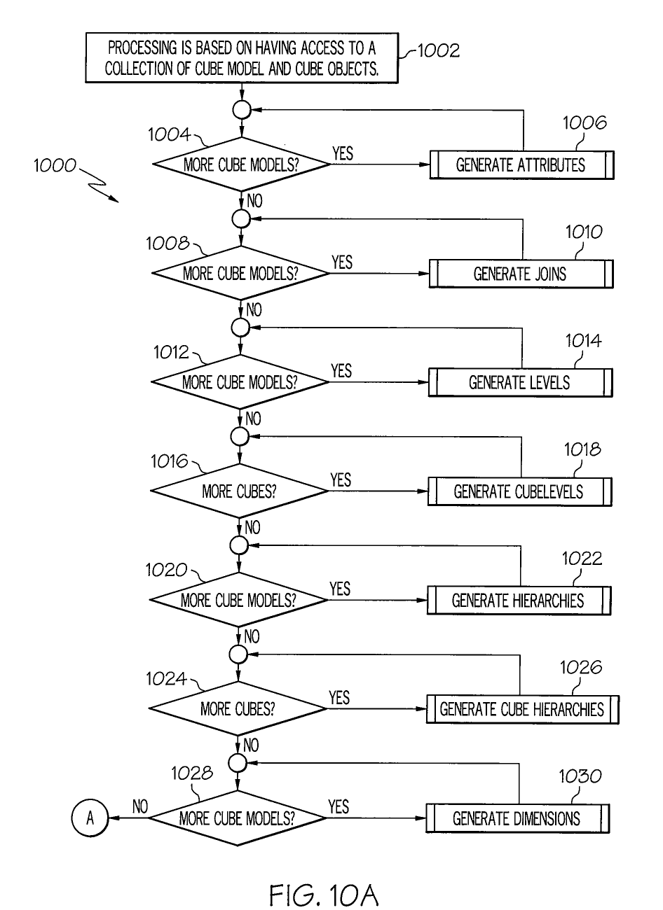

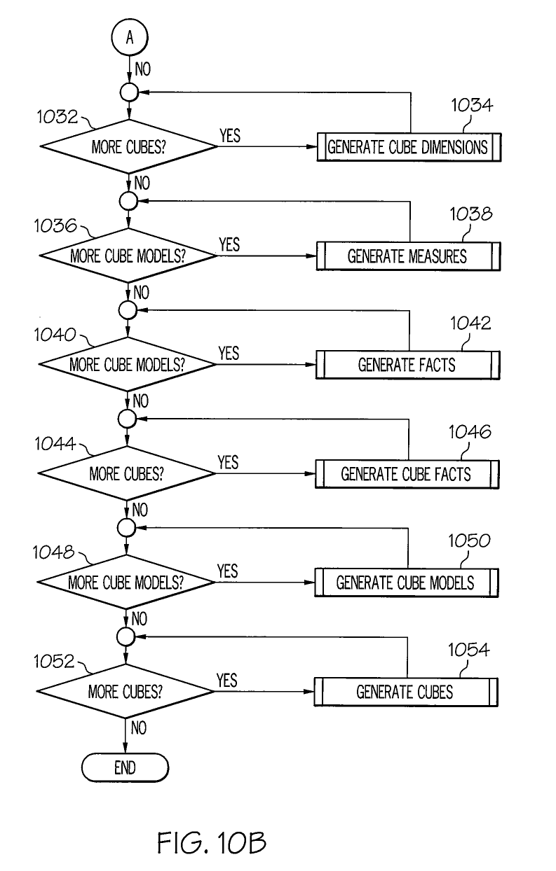

FIGS. 10A and 10B (collectively FIG. 10) are a flow chart of an example of a method 1000 for metadata file processing associated with creation of a star-schema database structure and a cube in accordance with an embodiment of the present invention. In accordance with an embodiment of the present invention, an XML schema may be defined for DB2 Cube Views metadata or the like and an XML file that adheres to the defined schema may be built using a process like method 1000. The method 1000 illustrates processing that may take place to produce a cube model in the form of an XML file or the like (model_cv.xml). In block 1002, the processing may be based on having access to a collection of cube models and cube models objects. In block 1004, a determination may be made if there are more cube models to be processed. If there are more cube models to be processed, attributed may be generated in block 1006. Accordingly, the method 1000 may iterate through all cube models and generate all attributes related thereto in block 1006.

In blocks 1008 and 1010, the method 1000 may iterate through all cube models and generate all joins associated therewith in block 1010. After the last cube model, the method 1000 may advance to block 1012. In blocks 1012 and 1014, the method 1000 may advance through all cube models and generate all levels in block 1014. After the last cube model, the method 1000 may advance to block 1016.

In blocks 1016 and 1018, the method 1000 may iterate through all cubes and generate associated cube levels in block 1018. After the last cube, the method 1000 may advance to block 1020. In block 1020 and 1022, the method 1000 may iterate through all cube models and generate all associated hierarchies in block 1022. The method 1000 may advance to block 1024 after the last cube model.

In blocks 1024 and 1026, the method 1000 may iterate through all cubes and generate cube hierarchies associated therewith. The method 1000 may proceed to block 1028 after the last cube in block 1024. In blocks 1028 and 1030, the method 1000 may process through each cube model and generate dimensions related to each cube model in block 1030. The method 1000 may proceed to block 1032 after the last cube model in block 1028.

The method 1000 may advance through all cubes in blocks 1032 and 1034 and generate cube dimensions associated with each cube in block 1034. In blocks 1036 and 1038, the method 1000 may process each cube model to generate measures associated therewith in block 1038. In blocks 1040 and 1042, the method 1000 may process through each cube model and generate facts associated with each cube model in block 1042. In blocks 1044 and 1046, the method 1000 may iterate through each cube and generate cube facts in block 1046. In blocks 1048 and 1050, cube models may be generated in block 1050 by processing each cube model and in blocks 1052 and 1054 cubes may be generated.

Each of the generate modules, such as generate attributes 1006, generate joins 1010 and so forth, may produce a snippet of XML metadata using various internal objects to construct the XML in the order expected by the DB2 schema or other relational database management system (DBMS) schema.

FIG. 11 is a flow chart of an example of a method 1100 for timer processing associated with creation of a star-schema database structure and a cube in accordance with an embodiment of the present invention. The method 1100 may be used for processing the timers within a monitoring context in block 624 of the method 600 of FIG. 6. In block 1102, a determination may be made whether there are more metrics within a monitoring context to be processed. If there are no more metrics to be processed, the method 1100 may end at termination 1104. If there is another metric to be processed, the method 1100 may advance to block 1106. In block 1106, a determination may be made if the metric is a fact. If the metric is not a fact, the method 1100 may return to block 1102 to determine if there are more metrics to be processed. Accordingly, the method 1100 will iterate through all metrics of a monitoring context. If the metric is determined to be a fact in block 1106, the method 1100 may proceed to block 1108. In block 1108, all aggregation measure names and types may be determined from the cube model. For example, “count,” “sum,” “avg,” or other aggregate measure names and types may be determined. In block 1110, a measure, attribute, data type, SQL expressions and the like may be created based on the current metric. The method 1100 may then return to block 1102 to continue iterating through all of the metrics associated with the monitoring context.

A similar method to method 1100 may be used to iterate through all the metrics to process the counters within a monitoring context in block 626 of the method 600 of FIG. 6.

FIG. 12 is a diagram of an exemplary system 1200 for dynamic creation of a star-schema database structure and a cube in accordance with an embodiment of the present invention. A process 1202, such as a business process or other process may be modeled by a modeling tool 1204 to form an observation model 1206 or the like. The modeling tool 1204 may involve forming a FDL/BPEL process description 1208 or a custom process description 1210. The observation model 1206 may be a digital or electronic representation or description of the process that can be inputted into a schema generator 1212 and used by the schema generator 1212 to generate and/or modify a datastore 1214 or data schema. The schema generator 1212 may include modules 1216 that may use the data schema 1214 to form a cube model 1218 from which a cube may be formed similar to the exemplary cube 500 of FIG. 5. As previously described, the actual number of cube models and cubes generated may depend upon the complexity of the observation model. The methods 100, 600, 700, 800, 900, 1000 and 1100 of FIGS. 1 and 6-11, respectively, may be embodied in the schema generator 1212. Accordingly, the schema generator 1212 may include modules 1216, components or data structures to perform functions or operations similar to the blocks or modules in methods 100 and 600-1100. The schema generator 1212 may form metadata objects 1220 associated with the cube model 1218 to manipulate and manage fact tables 1222 and related dimensional tables 1224 in a relational database 1226 or the like. The tables 1222 and 1224 may form a star schema or other type schema database structure.

Metrics 1228 contained in the tables 1222 and 1224 may be indexed and a dynamic, optimized structure or cube may be formed using the cube model 1218 by the schema generator 1212 that facilitates extraction of data from the data store 1214. The data from the cube may be presented to a user in the form of a dashboard 1230, user interface, printed hard copy, or similar means of presentation.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for creation of a database structure and associated cube, comprising:
identifying processes associated with an observation model;
identifying any metrics associated with each process to be recorded;
constructing a database schema to store the metric data and provide appropriate interrelations between the processes; and
creating a cube model and a cube based on the database schema that can be queried to provide desired output information.

2. The method of claim 1, further comprising creating a metadata file that describes a cube structure.

3. The method of claim 1, further comprising mapping between each of a plurality of cube artifacts and the database schema.

4. The method of claim 1, further comprising:
iterating through each monitoring context of the observation model; and
creating a cube model object to represent each monitoring context.

5. The method of claim 4, further comprising processing within each monitoring context a group comprising at least one of a metric, a timer and a counter.

6. A method of claim 4, further comprising generating a time dimension for each cube model.

7. The method of claim 4, further comprising generating a measure for a primary key for each cube model object.

8. The method of claim 1, further comprising further comprising:
creating a plurality of internal objects to represent each of a group comprising at least one of a dimension, a level, an attribute, a hierarchy, an SQL expression, and data types for year, month and day columns that are part of a time dimension; and
adding the plurality of internal objects to a cube model.

9. The method of claim 1, further comprising:
determining whether a metric is one of a fact and a dimension; and
creating a group comprising a measure, attribute, data type and SQL expression for each fact.

10. A system for creation of a database structure and an associated cube, comprising:
a schema generator to construct a database schema to store metric data and provide appropriate interrelations between processes of an observation model, the schema generator comprising:
a module to generate a table corresponding to each process in the observation model; and
another module to provide a column in the table for each process to store each metric associated with a particular process; and
a module to create a cube based on the database schema that can be queried to provide desired output information.

11. The system of claim 10, further comprising a module to create a metadata file that describes a cube structure comprising a plurality of cube model objects.

12. The system of claim 10, further comprising a module to map between each of a plurality of cube artifacts and the database schema.

13. The system of claim 10, further comprising:
a component to iterate through each monitoring context of the observation model; and
a component to create a cube model object to represent each monitoring context.

14. The system of claim 10, further comprising:
a component to determine whether a metric is one of a fact and a dimension; and
a component to create a group comprising a measure, attribute, data type and SQL expression for each fact.

15. A computer program product for creation of a database structure and an associated cube, the computer program product comprising:
a computer usable medium having computer usable program code embodied therewith, the computer usable medium comprising:
computer usable program code configured to construct a database schema to store metric data and provide appropriate interrelations between a plurality of processes associated with a process model; and
computer usable program code configured to create a cube based on the database schema that can be queried to provide desired output information.

16. The computer program product of claim 15, further comprising computer usable program code configured to create a metadata file that describes a cube structure.

17. The computer program product of claim 15, further comprising computer usable program code configured to map between each of a plurality of cube artifacts and the database schema.

18. The computer program product of claim 15, further comprising:
computer usable program code configured to iterate through each monitoring context of the observation model; and
computer usable program code configured to create a cube model object to represent each monitoring context.

19. The computer program product of claim 15, further comprising:
computer usable program code configured to create a plurality of internal objects to represent each of a group comprising at least one of a dimension, a level, an attribute, a hierarchy, an SQL expression, and data types for year, month and day columns that are part of a time dimension; and
computer usable program code configured to add the plurality of internal objects to a cube model.

20. The computer program product of claim 15, further comprising:
computer usable program code configured to determine whether a metric is one of a fact and a dimension; and
computer usable program code configured to create a group comprising a measure, attribute, data type and SQL expression for each fact.
